(19) United States
(12) Patent Application Publication
(10) Pub. No.: US 2019/0000022 A1
(43) Pub. Date: Jan. 3, 2019

(54) METHOD AND APPARATUS FOR ELIMINATION OR REDUCTION OF THE DESTRUCTIVE FORCE OF SPIRALING WIND STORMS

(71) Applicant: QUSSAY ABDULATTEEF JASIM AL-AANI, Tampa, FL (US)

(72) Inventor: QUSSAY ABDULATTEEF JASIM AL-AANI, Tampa, FL (US)

(21) Appl. No.: 15/928,517

(22) Filed: Mar. 22, 2018

Related U.S. Application Data
(60) Provisional application No. 62/601,693, filed on Mar. 27, 2017.

(51) Int. Cl. A01G 15/00

(52) U.S. Cl. CPC A01G 15/00

(57) ABSTRACT

Stopping the Tornadoes and Hurricanes using very simple method of trying to mix water with clay dust or cement or any dry powder which mixes well to form mixture of heavy material (clay mixture) which makes the storm circulating water lose its energy and dissipate and this can be done by throwing Dust in the lower part of the funnels or lower part of the center of the storms to make sure not to scatter, In natural environment Stopping the Tornados and Hurricanes can be done using fire fighter airplane but throwing clay, cement, talcum dust as or using open trucks loaded with dust clay or cement or any gypsum materials mix well with water directed to park remotely using radar to the expected position of the tornado when the dust will be sucked into the funnel of the tornado and dissipate.

### TECHNICAL FIELD OF THE INVENTION

The present invention relates to spiraling wind storms, such as storms referred to commonly as tornados and hurricanes, and more particularly to methods and compositions for reducing the destructive force caused by such spiraling wind storms, by fostering the dissipation of such wind

### BACKGROUND OF THE INVENTION

Every year, highly destructive spiraling wind storms are responsible for large scale losses of life and the destruction of property. Two primary categories of such spiraling wind storms include tropical cyclones and tornados. A tropical cyclone is a storm of a cyclonic nature that is often referred to by such terms as hurricane, typhoon, tropical storm, cyclonic storm, tropical depression, or sometimes as a cyclone.

A tornado is a storm that includes a violently rotating column of air that is in contact with both the surface of the earth and a cumulonimbus cloud (or in rare cases, the base of a cumulus cloud). Tornados are referred to often as “twisters” or “cyclones”.

As will be discussed below, hurricanes and tornados both involve spiraling winds of great force, that are capable of creating great destruction. However, as discussed below, significant differences exist between tropical cyclones and tornados.

As used in this application, the term “tropical cyclone” or “hurricane” will be used to generically refer to tropical cyclonic storms that include storms referred to as hurricanes, typhoons, tropical storms, cyclonic storms, tropical depressions, or cyclones. The term “tornado” or “twister” will be used to refer to storms that are referred to commonly as twists, cyclones and, if formed over water, water spouts.

### A/Tornados FIG. 1

In its broadest sense, tornados include any closed, low pressure circulation event. Tornados come in many sizes and shapes, but typically are in the form of a visible condensation funnel, having a lower end and an upper end. The narrower lower end touches the earth and is often circled by a cloud of dust and debris. The upper end depends from a cloud system, that typically comprises a cumulonimbus cloud and may comprise a cumulus cloud. Tornados have wind speeds usually less than 110 mph, for category (1) and can have speed in excess of 200 mph for category (5), although tornadoes having wind speeds in excess of 300 mph have been recorded.

In the United States, tornados generally average approximately 500 feet across in diameter (150 meters), but more than (1) mile wide have been recorded and travel on the ground for an average of approximately about five miles (8.0. km) but can stay on the ground over 50 miles.

The average forward speed of tornado is 30 mph but may vary from nearly stationary to 70 mph

An average year, 1,200 tornadoes cause 60-65 fatalities and 1,500injuries nationwide Tornado size however can vary widely, with one tornado having a damage path of only approximately seven feet in width, where a 2004 tornado in Nebraska had a width of approximately 2.5 miles (4.0 kilometers) on the ground.

An extreme tornado was the Tri-State Tornado that traveled through parts of Missouri, Illinois and Indiana on 18 Mar. 1925. The Tri-State Tornado was believed to be on the ground continuously for over 219 miles (352 km). Although the Tri-State Tornado was believed to be a single tornado, a more common occurrence that extends the effective “destructive area” of a tornado is a phenomena known as a family of tornados. In a family of tornados, a single strong storm cell may generate a plurality of tornados, that are formed at or about the same time or in quick succession. Additionally, an especially strong or vicious storm cell may travel across several states generating a plurality of temporally and geographically spaced tornados as the storm travels across the areas in its path. As such, it is quite common for a single particularly vicious storm cell to produce tornados in several states on its path.

Tornados often develop from a class of thunderstorms known as super cells. Super cells contain mesocyclones, that are areas of organized rotation a few miles up in the atmosphere. In addition to generating tornados, super cells often generate very heavy rain, frequent lightening, strong wind gusts and hail. Typically, tornados spawn due to the existence of increasing rainfall that drags with it an area of quickly descending air known as the rear flank downdraft (RFD). This downdraft accelerates as it approaches the ground and drags the super cells rotating mesocyclone toward the ground with it.

As the mesocyclone lowers below the cloud base, it begins to take in cool moist air from the downdraft region of the storm. Along with the cool moist air in the downdraft region of the storm, there also exists warm moist air in the updraft portion of the air. This convergence of the warm air in the updraft and the cool air in the downdraft causes a rotating wall cloud to form.

The rear flank downdraft also focuses the mesocyclone's base, causing it to siphon warm moist air from the small area on the ground that becomes the warm moist air updraft. As the updraft intensifies, it creates an area of low pressure at the surface, that pulls the mesocyclone down, in the form of a visible condensation funnel. As the funnel descends, the rear flank downdraft also reaches the ground causing a gust front that causes severe damage a good distance from the tornado. Usually the funnel cloud begins causing damage on the ground, and becomes a tornado within a few minutes of the rear flank downdraft reaching the ground. The tornado is powered by the source of warm air in the updraft. It is believed that as the warm moist air is pulled upward, the moisture within the air condenses. This latent heat of condensation is an exothermic event that provides power to the tornado, and helps to create an extremely low pressure area within the center of the tornado.

These exothermic driving forces happen within the eye of the storms and above the ground between the ground and first 100 ft to 1000 ft approximately and may be at much greater height depending on the storm size.

The tornado is powered by the source of warm air in the updraft. It is believed that as the warm moist air is pulled upward, the moisture within the air condenses. This latent heat of condensation is an exothermic event that provides power to the tornado, and helps to create an extremely low pressure area within the center of the tornado.

The source of warm, moist inflow air into the tornado continues to power it, causing the tornado to grow until it reaches a mature stage. Typically, the time span between the formation of the tornado and its reaching the mature stage can be anywhere between a few minutes to more than one hour. It is during this time that the tornado usually causes its most significant damage, and grows to its largest size that can be more than a mile (1.6 km) in diameter.

Concurrently with this, the rear flank downdraft (RFD) becomes an area of cool surface winds that begins to wrap around the tornado to thereby cut off the inflow of warm moist air that feeds the tornado. If the RFD completely wraps around and chokes off the tornado's supply of warm moist air, the vortex begins to weaken and becomes more thin and rope like. This is referred to as the dissipation stage of the tornado, and often lasts no more than a few minutes. After the dissipation stage, the tornado phases out.

During the dissipation stage, the shape of the tornado becomes highly influenced by the winds of the parent storm and it can be blown into a wide variety of patterns. Although dissipating and decreasing in diameter, the tornado is still capable of causing damage, as the decrease in diameter is often accompanied by an increase in wind speed.

As also discussed above, super cells are capable of producing a plurality of tornados. Even as the first mesocyclone and its associated tornado dissipate, the storms inflow of warm moist air may be concentrated into a newer area closer to the center of the storm. If a new mesocyclone develops, and lowers itself to the ground, the cycle may begin anew, with a new tornado being formed.

B/Hurricanes (Tropical Cyclones), FIG. 2

A tropical cyclone (often referred to as a hurricane) is a storm system that is characterized by a low pressure center, surrounded by a spiral arrangement of thunderstorms that produce strong winds and heavy rains. Typical tropical cyclones strengthen when water evaporated from the ocean is released as the saturated air rises, resulting in condensation of water vapor contained in the moist air. This latent heat of condensation is exothermatic, and generates energy, a fraction of which is used by the storm to increase its strength.

Tropical cyclones produce extremely powerful winds and torrential rains. Additionally, they are capable of producing high waves, damaging storm surges and tornados. They tend to develop over large warm bodies of water, and lose their strength if they either move over land, due to increase surface friction and the loss of the warm ocean as an energy source, or they move over colder water, as colder water does not produce the same quantities of energy as warm water on which the tropical cyclone can feed.

All tropical cyclones are areas of low atmospheric pressure in the earth's atmosphere. The pressures recorded at the centers of tropical cyclones are among the lowest to occur on the earth's surface at sea level. Tropical cyclones are typically characterized and driven by the release of large amounts of latent heat of condensation. This latten heat of condensation is given off when warm moist air is carried upward, such as through the evaporation of warm ocean water. As the warm moist air is carried upward, it cools because of the cooler temperatures found at higher elevations. This cooling causes the water vapor within the moist air to condense, thus giving off the latent heat of condensation, which is an exothermal event. This heat is distributed vertically around the center of the storm.

This heat driving forces happen within the eye of the storms and above the ground between the ground and first 100 ft to 1000 ft approximately and may be at much greater height depending on the storm size.

Because the warm moist air is pulled up through the center of the storm, adjacent to the eye of the hurricane, the environment inside a cyclone is generally warmer than its outer surroundings.

At the very center of a cyclone, a cyclone will typically have an area of sinking air. If this area is strong enough, it can develop into an area that is known as the “eye of the hurricane”. Weather in the eye is normally calm and free of clouds, although the sea through which the eye passes may be extremely violent. An eye of a hurricane or tropical cyclone is generally circular in shape, and has a diameter of between 19 to 40 miles (30.65 km), although eyes as small as 3 km and as large as 370 km (1.9 miles and 230 miles), have been found. A tropical cyclones primary energy source is the release of the heat of condensation from the water vapor condensing, with solar heating being the initial source for the evaporation. .

Therefore, a tropical cyclone can be visualized as a giant vertical heat engine supported by mechanics driven by physical forces such as rotation and gravity of the earth.

An initial organised thunderstorm complex is necessary for the formation of a hurricane.

Additionally, a large influx of energy is needed to lower atmosphere pressure more than a few milibars (0.1 inch, Hg). The inflow of warm air moisture from the underlying ocean surface is critical for a tropical storm to strengthen as the warm ocean moisture provides the energy in the form of the warm moist air from which the moisture can later condense.

Condensation of the warm moist air leads to higher wind speeds, as a tiny fraction of the released energy is converted into mechanical energy. The faster winds and lower pressure associated with this release of mechanical energy in turn causes increased surface evaporation of warm moist air, thus resulting ultimately in a greater amount of condensation, that thereby results in a greater release of energy. Much of the released energy drives updrafts that increase the height of the storm clouds that thereby speeds up condensation.

This positive feedback loop continues for as long as conditions are favorable for tropical cyclone development. Factors such as a continued lack of equilibrium and air mass distribution also give supporting energy to the cyclone.

Deep convection as a driving force, distinguishes tropical cyclones from other meteorological phenomena. Because convection is strongest in a tropical climate, tropical climate-like conditions are often required to initiate a hurricane.

To continue to drive its heat engine, a tropical cyclone must remain over warm water that provides the needed atmospheric moisture to feed the positive feedback loop. When a tropical cyclone passes over land, it is cut off from its heat source and its strength diminishes rapidly. The passage of a tropical cyclone over the ocean causes the upper layers of the ocean to cool substantially, because of the wind driven mixing the warm surface waters with cold water from deeper in the ocean. This effect results in a negative feedback process that can inhibit the further development of the hurricane or weakening. Additional cooling can come in the form of colder water from rain drops, or from the storm moving over colder waters, such as when the storm migrates northward.

The force released by a tropical cyclone is incredibly large, having been estimated somewhere between 50 and 200 exajoules (10¹⁸ J) per day. This rate of energy release is equivalent to 70 times the world energy consumption of humans and 200 times the world wide electrical generating capacity.

The exothermic events and all driving forces such as condensation which can convert the hurricane or tornado into a giant vertical heat engine supported by mechanics driven physical forces all in the lower part say first half mile from the ground which ow project should concentrate on this lower half mile to stop the heart of the driving force of the tornado or hurricane

### C/The Effects of Particle Size

An important concept to understand relates to the size of moisture particles in the air, and the effect of such size upon the particles. A typical raindrop is about two millimeters in diameter. A typical cloud drop is much smaller and has a diameter on the order of 0.02 millimeters. Even smaller is a typical cloud condensation nucleus that has a diameter of 0.1 micrometer (or pm 10).

The number of cloud condensation nuclei in the air can be measured, and ranges typically between about 100 to 1000 nuclei per cubic centimeter. Large concentrations of these are responsible for cloud condensation nuclei. The ability of these different types of particles to form cloud droplets varies according to their size and their exact contribution, and also depends on the ability of the particles to readily absorb water, the details of which are still not well understood.

The size of the particle will also affect its ability to fall out of the air and strike the earth. The fall rate of very small droplets is negligible. Because of this, clouds remain in the sky. Rather, moisture droplets fall to earth as precipitation when these cloud droplets collect into larger droplets. When air turbulence occurs, water droplets collide to produce larger droplets. As these larger droplets descend, coalescence continues so that the droplets become heavy enough to overcome air resistance and fall in the form of rain.

Hail forms in storm clouds when super cooled water droplets freeze on contact with condensation nuclei, such as dust or dirt. The updraft of a storm blows the hail storms to the upper part of the cloud. The updraft dissipates and the hail stones fall down back into the updraft and are lifted again and so on.

### D/Prior Known Efforts to Actually Dissipate Spiraling Storms

In the 1960s and 1970s attempts were made to weaken hurricanes by seeding selected storms with silver iodide. It was believed that such seeding would cause super cooled water in the outer rain bands of hurricanes to freeze, thereby causing the inner eye wall to collapse and reducing the winds. Although such seeding operations had some success, they did not prove to be effective in the long term. For example, one storm that was seeded did lose its strength initially, but quickly regained it within a day or so after being seeded. Another storm changed its course after being seeded, thus making the hurricanes path less predictable.

In general, seeding experiments were later discontinued, since it was found that although seeding did help to cause the inner eye wall to collapse, eye wall replacement cycles occur naturally in strong hurricanes. Further, it is believed that seeding with silver iodide is likely not to be successful due to the fact that the amount of super cooled water in the rain bands of a tropical cyclone are too low to be able to achieve the effects desires by seeding.

Other attempts at dissipating hurricanes have included dropping large quantities of ice into an eye of the storm at the very early stages of its development and one project considered blasting the cyclone apart with nuclear weapons

Another method was to throw Cement and dust and clay dust and other silicon water absorbent materials but without success because all these materials are thrown out to the perimeters of the cyclone or the upper perimeter of the eye of the tornadoes or Tornado outer surface, due to the upcoming storm winds from the earth direction to the cyclone and Tornado upper parts and it was clear to see that any cement or powder where thrown on the eye or eye upperparts perimeter were dispersed and where pushed upward due to the updraft of the hot air coming from the ground lower funnel eye and this approach had very little effect and was unsuccessful in stopping the tornadoes or the hurricanes.

Unfortunately, the approaches discussed above were not successful. It is believed that one reason for the failure of such prior attempts is that tropical cyclones are simply too large and too short lived for any of the weakening techniques to be practical and useable in dissipating their strength.

### SUMMARY OF THE INVENTION

the exothermic driving forces(drive the storm heat engine), happen within the eye of the storms and above the ground between the ground and the first 100 ft to 1000 ft approximately depending 230 on the size of the storm to mix with the fine clay or cement or talcum powder and the storm water droplets to form much heavier particles and stop rotating and dissipate the storm and the fine clay or cement or talcum powder will have no effect if thrown above these heights and will be pushed up outside the storm perimeter.

In accordance with the present invention a method and composition are provided for promoting the dissipation of a spiraling wind storm, such as a tornado or hurricane. A significant quantity of a small particle material (Dust Particles) is provided.

using several methods (will be listed and described latter) full cement bags carrying cement, fine clay or fine talcum powder or any fine particle absorbing water(see FIG. 3 with both of their carrying strap are strapped to the bottom of the bags so when thrown away with the cement bag upward are turned 180 degree vertically making the mouth of the bag facing the ground at specific strap (rope connected and fixed to the airplane or any other flying machine) length according to the height of the plane or the rope connected to helicopters and length of the rope will give the starting point of the fine clay or cement or debris to start spreading at specific height inside the tornado or hurricane preferably near the ground or where this fine debris height will be most effective to dissipate the tornado or hurricane damaging winds and full study of this event may be carried out for future storms dissipation and these cement or clay bags will not harm or damage human or properties on the ground when dropped from the sky.

The above cement bags carrying one ton or one and half ton standard cement bags with open top but covered with easily movable top (to protect the fine cement or fine clay from moist) until thrown inside the hurricane and reaches the eye center and these bags are filled with fine clay or cement or any water absorbent material. The small particulate matter is introduced to the center lower part near the ground level(lower part of the tornado funnel) or the hurricane base where the heated air is entering the storm lower end touching or near the ground surface in which the heated mixture of water and air start to rises in the center of the funnel wall of the storm which is the primary source of driving the storm strength exothermal condensation takes place and become the main driving source of energy of the storm, and this is the place where all the clay or cement or any material that will mix and react to form much heavier rain-clay drops which will disoriented the circular path of the storm inner walls and this event can be seen taking place in the Tornados in (May 24, 2016 Dodge City KS Tornado) & Tornado in rago, Kansas, may 19, 2012

When these tornados meet fine clay and fine sand and debris on the ground or near the ground in sufficient quantity, tornados are completely dissipated and collapsed or weaken a lot depending on the sand and debris quantity on the ground which will mix and to fully or partially cover the inner funnel body of the storm. The particulate material is mixed into the storm to mix with the moisture in suspension or as rain drops, so that the fine moisture and water particles that mix with the particulate will form larger and heavier water droplets around the particulate.

Preferably, the small particulate matter filing the cement bags above comprises a water-absorbent small particulate matter, such as silt, clay, dust, fine cement, fine chalk, talcum powder, ash or any other natural or man-made material, that can be generated as a small particulate.

### Methods of Introducing Fine Clay or Cement or Water Obsorbent Materials to the Lower Part of Tornados or Hurricanes

In accordance with the present invention, several delivery vehicles are provided and disclosed for delivering the particulate matter into a storm as described above. These delivery vehicles include air x craft-type delivery vehicles, such as airplanes and helicopters of the type used currently to apply a fire retardant to a fire situation on forests.

Other delivery vehicles can include such things as balloons, hoses, and propellant mechanisms such as “cannons” that are capable of launching bags of particulate matter into the storm or hurricane inner centers.

One feature of the present invention is that particulate matter can be introduced into a storm to facilitate dissipation of the storm, and a reduction of the storm's energy. By weakening its energy and hastening its dissipation, it is hoped that these storms will have less energy with which to damage property and cause injuries to animal and human life. These and other features and advantages of the present invention will become apparent to those skilled in the art upon a review of the detailed description and drawings below that discuss the best mode of practicing the invention perceived presently.

### BRIEF DESCRIPTION OF DRAWINGS

FIG. 1 view of tornado-type storm;

FIG. 2, sketch showing the formation of a Hurricane into the clouds near Florida

FIG. 3, Cement bags modified to carry Fine clay &fine sand with straps to empty the content inside the bottom of the tornado funnel with long straps attached at the bottom of these bags to turn 180 deg to mix the fine clay with the tornado water at the bottom of the tornado near the ground or with small timed explosives devices to release the clay dust at the bottom of the funnel near the ground

FIG. 4 Different type of bags making sure to have water resistance cover and body to keep the dry fine clay dry but the handle straps should be attached to the bottom of the bags with appropriate rope lengths to reach the lower the part of tornado funnel

FIG. 5 is a view of FIRE FIGHTERS SPRAY WATER ON FOREST FIRES illustrating the various fixed and rotating wings of the aircraft that could be used to disburse the storm using the cement bags method or clay dust to be thrown into the funnel of the tornado or hurricane as described earlier filled with fine clay or cement or powder to dissipating particulate matter of the present invention into the storm lower part near the ground

FIG. 6 is a view showing a dust storm front moving into an area in Arizona which will dissipate if meet wet thunderstorm or tornado which illustrate the patent principal, schematic tornado meeting desert storms (will dissipate in very short time)-desert storm the enemy of tornadoes

FIG. 7 evaporation with energy release causing positive feedback loop

FIG. 8 A is schematic view illustrating the travel of gas through a liquid interface;

FIG. 9 B is a schematic view showing the passage of liquid through a solid interface

FIG. 10 is a schematic view illustrating dust forming in desert storms and saltation effect of particle weight on lift force in a cyclonic storm

FIG. 11 Desert storm in full strength

FIG. 12 is a graphic view illustrating an atmospheric water cycle

FIG. 13 Tropical cyclones form when the energy released by condensation of moisture in rising air causes appositive feedback loop over Warm Ocean waters

FIG. 14 Tornado Ally crosses the middle part and south the USA

FIG. 15 Tornado alley showing the air movements causing tornadoes

FIG. 16 is a view showing a map of the United States highlighting the areas in which tornado activity is more likely to occur

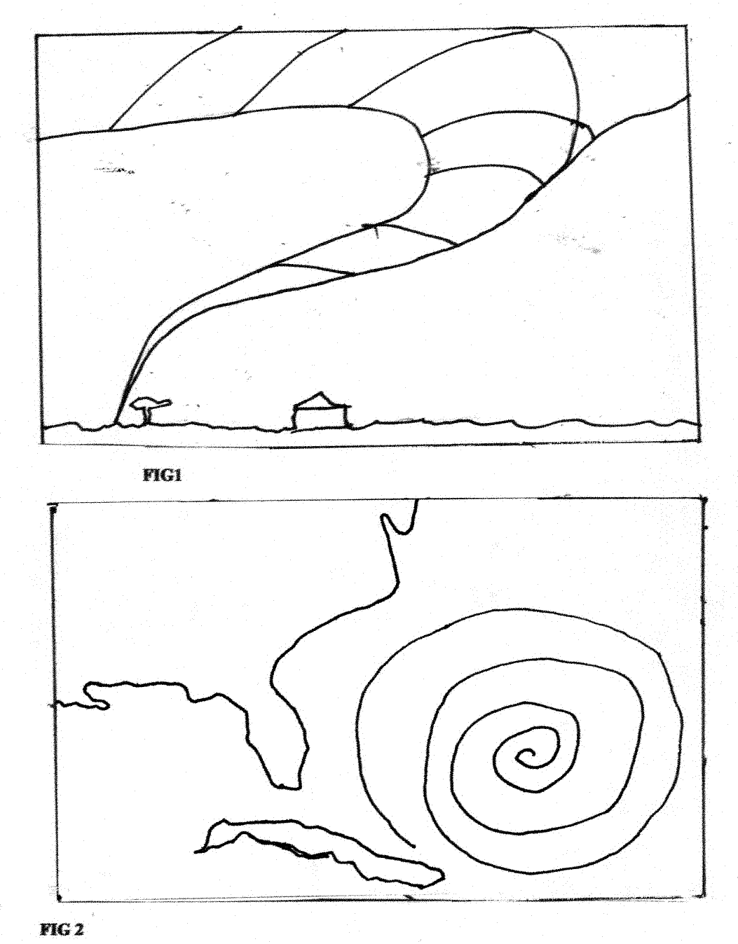

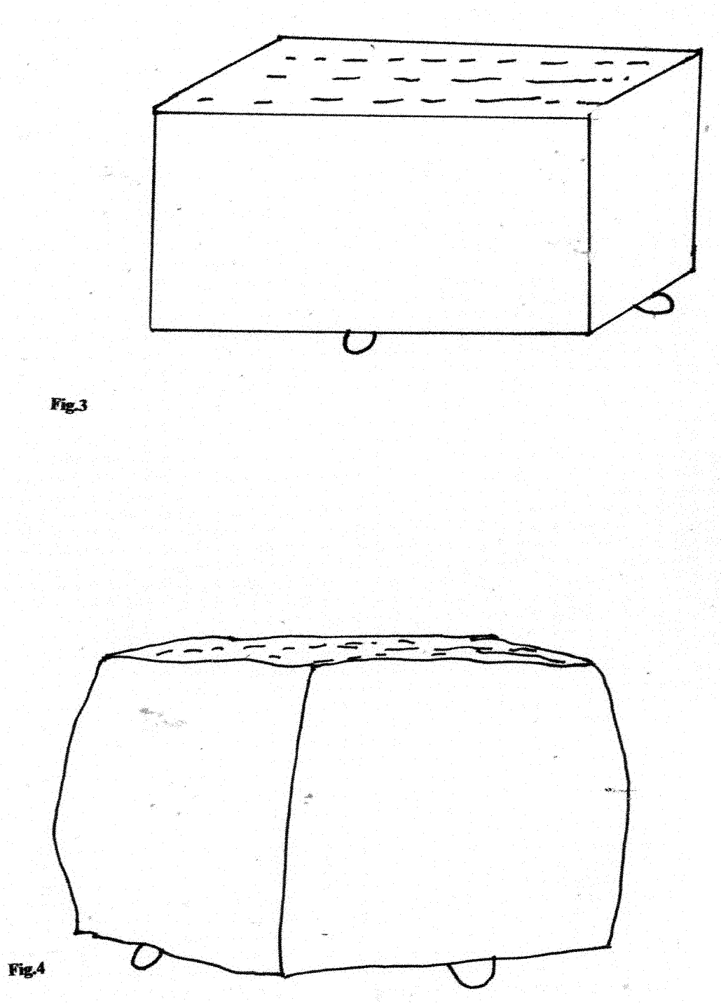

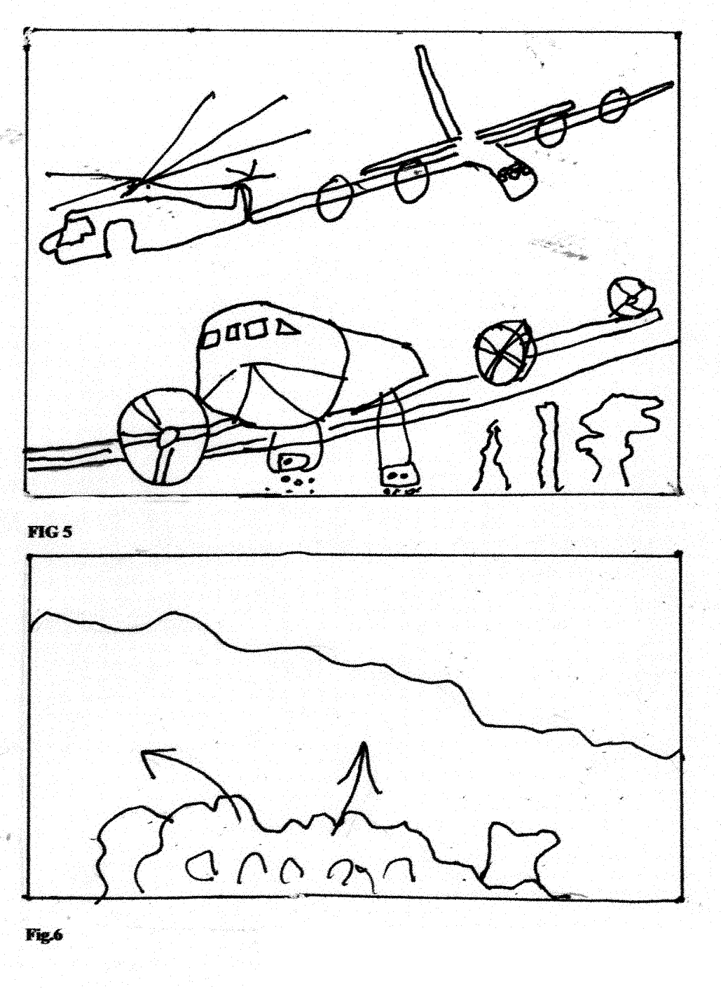

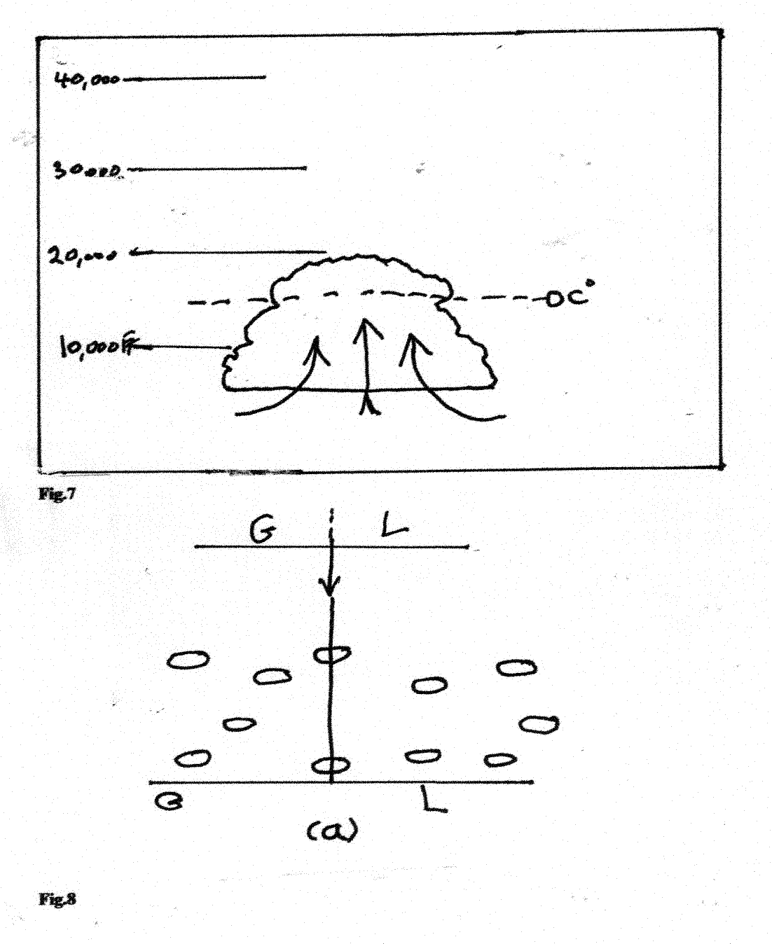

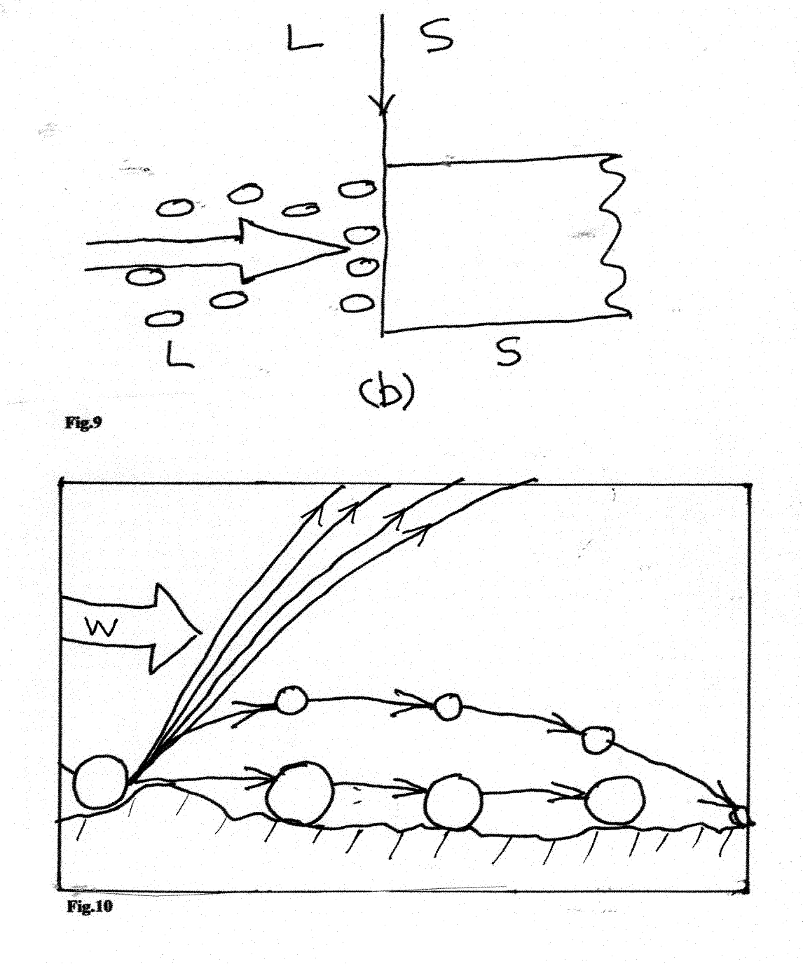

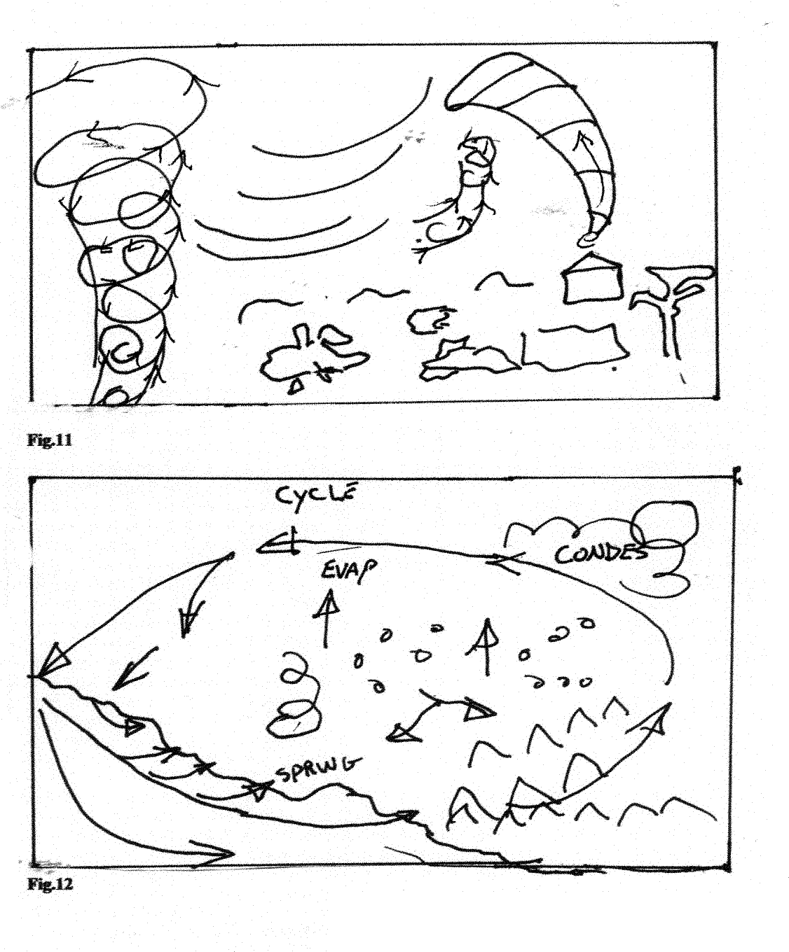

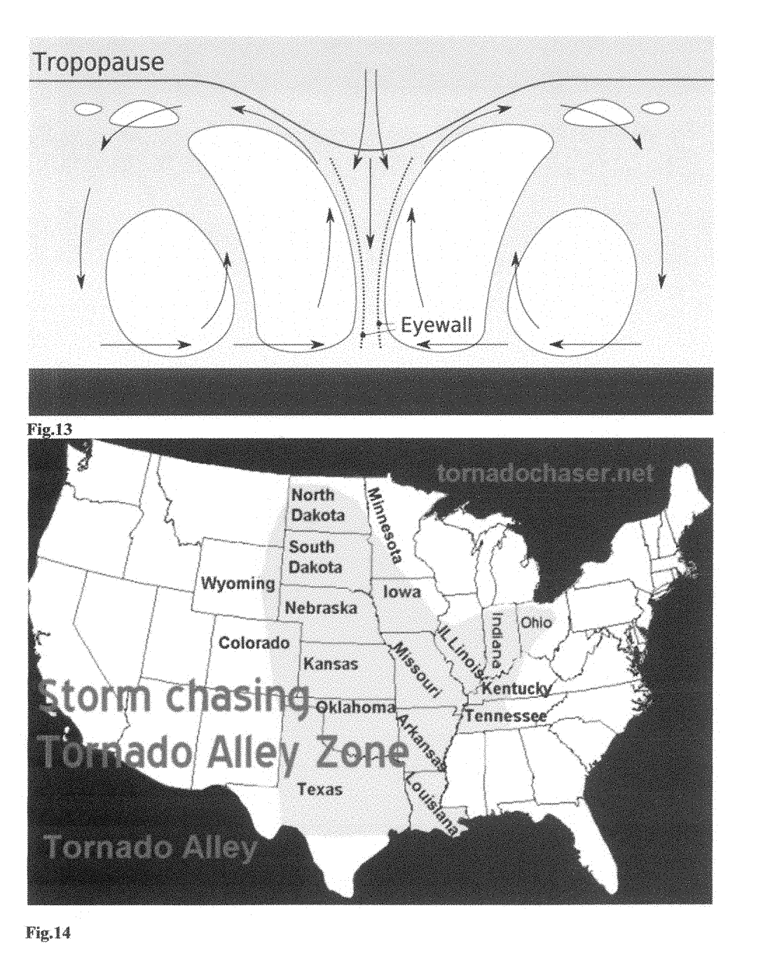

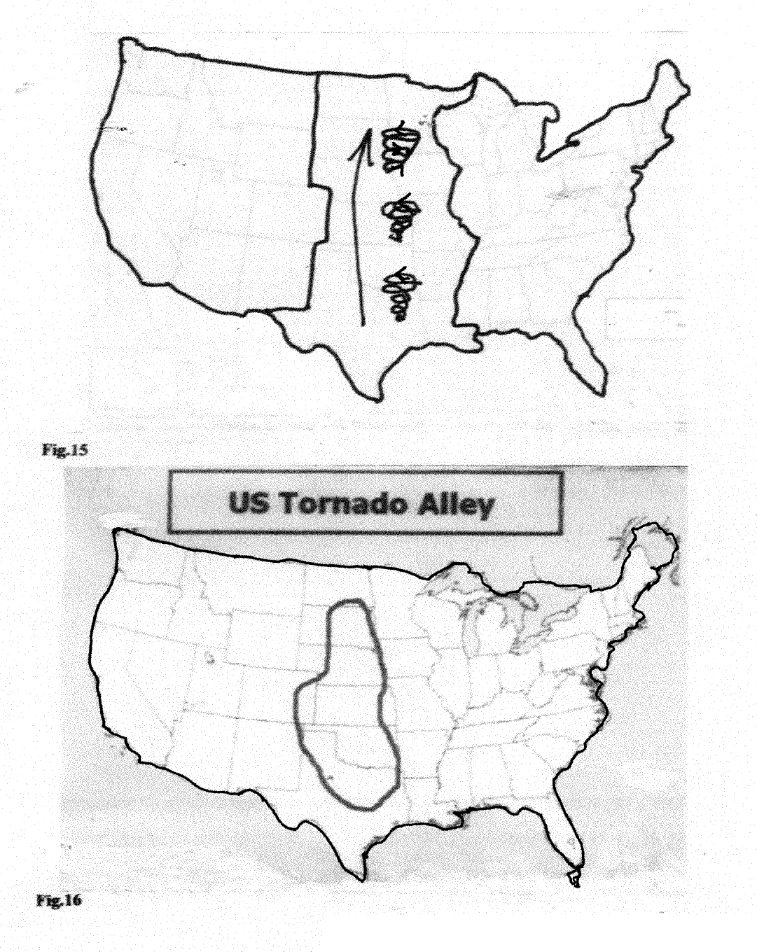

### DETAILED DESCRIPTION OF THE PREFERRED EMBODIMENT

At its core, the present invention comprises the gathering, manufacture and/or provision of water absorbent, small particulate matter material. This water absorbent, small particulate matter is introduced into a storm, such as a tornado or hurricane, through the use of a delivery vehicle, such as an aircraft. The water absorbent particulate material then absorbs moisture or water within the storm, forming a heavy, water laden particulate. This heavy particulate absorbs energy from the storm to thereby lead to the dissipation of the storm, or its weakening.

### A. The Particulate Materials

According to one aspect of the present invention, a water absorbent fine particulate material is employed. The fine particulate material can comprise a material such as dust, silt, clay, fine cement, fine chalk, talcum powder, ash, water absorbent manufactured powders or any natural or man-made fine particles that mix well in water. The absorbent materials should be capable of mixing well enough in water, so as to absorb a large amount of water.

Preferably, a sufficient quantity of this fine particulate material is added to the storm to fully cover inner part the or at least partially the center and funnel body of the tornado or hurricane, or at least partially cover the tornado or hurricane inner cloud. The particular matter so introduced into the hurricane or tornado mixes with the moisture in suspension or as rain drops and fine water particles that make up the tornado or hurricane inner part body will mix with the fine particulate matter to make clay like particles that are heavy enough to disturb the tornado spiraling sequence in the funnel and cause a loss of energy to the twisting motion of the tornado and the funnel thereby dissipate the energy of rotation within the tornado.

The dust itself can preferably be fine dessert sand or fine clay dust having the diameter of approximately a micron or so.

The particulate should generally be small in size. Preferably, the particulate matter is smaller than fine sand (0.2 mm). Ideally, the particulate size is somewhere in the silt or fine silt range, generally being less than 0.063 mm in diameter. One benefit of particulates this size is that they are generally susceptible to becoming airborne, and carried by the wind. Among the types of materials that can fall within this size range, include such materials as fine cement particles, fine desert sand, fine clay dust, fine chalk particles, talcum powders, ashes and any natural or man-made fibers that mix well with water.

Absorbent manufactured products that will mix readily with water and are very easily carried by air in the form of dust will work well with the present invention. Further, chemical additives can be added to the small particulate matter, to enhance the ability of the particulate matter to absorb water or moisture, or to better mix with the moisture, and to better form into clay-like rain droplets.

As the preferred particulate matter is very prone to absorbing water, it is preferable to keep the particulate material as dry as possible, prior to its introduction into the storm to better help to preserve its water absorbing capacity. To this end, it may be useful to provide water resistant or water proof carriers bags specially modified to keep the materials dry and be released at the bottom of the funnel using straps as described previously that can help maintain the dryness of the absorbent material.

One such carrier comprises a cement bag-like carrier that is made of water proof material modified as previously described. Preferably, the material from which the particulate bag carrier is made should be strong enough to contain the particulate material, but still capable of easily release the dust into the atmosphere. Examples of such material include plastic containers, reinforced paper, or other materials that have water proof or water resistant characteristics and that can be designed to be opened easily using the ropes straps as described. For example, bags can be employed that include small explosive charges that can be remotely detonated, while the bag is in the storm bottom of the funnel, so that the bag explodes to thereby release the particulate materials.

One way to help facilitate the moisture proofing of the materials is to vacuum seal the bags, to keep the water or moisture out and to maintain the water and moisture from contacting the dust but the rope straps will release the particle at the wanted place to release the particles.

The dust operates to help dissipate the tornado by mingling and mixing with the water vapor and moisture within a tornado or hurricane inner funnel or inner part as near to the ground where the storm damage is at its peak. This mixing and mingling is facilitated by ionization charge between the dust and the water vapor, rain drops and other moisture within the storm.

Additionally, physical contact type mixing between the dust and the water will cause the particulate matter particles to become heavier due to the absorption of water by the particulate material. These heavier particles form clay-like mixtures that will develop in a manner similar to a manner in which hail stones develop. These clay-like droplets will reduce the velocity of water particles in the funnel and the storm that are absorbed by the clay materials due to the loss of energy and the destruction of the bonds and sequence in the tornado and hurricane structure.

Due to the loss of spinning energy possessed by the tornado, the rotation sequence and rotation strength of the cyclonic forces of the tornado are weakened. The reduction of the cyclonic movement of the forces tends to turn the tornado into more of a “vertical” rainstorm having clay-like droplets, rather than the cyclonic storm with the spiraling cyclonic winds that typically characterize a tornado or hurricane. The reduction of these cyclonic forces helps to reduce the energy of the tornado, and hence, the potential of the tornado to cause harm and destruction to both property and life forms.

The clay-like droplets that are formed through the introduction of the particulate matter will descend in small quantities without any harm in much the same manner that very small hail stones will fall to earth.

Preferably, the dust is disbursed on the lower part of a tornado (using cement bags as described above), through vehicles that are capable of rising above the tornado to drop the particulate matter downwardly into the tornado or storm funnel center. Preferably, the particulate matter is disbursed into the lower part of the funnel center of the tornado or into the eye or cloud body center of a hurricane. This invention predicts that the particulate matter is most effectively deployed into the tornado or hurricane at an early point in the life-cycle of the tornado or hurricane. Since tornados are usually short duration storms, some temporal difficulties will exist in trying to insert the particulate material into the tornado. Nonetheless, efforts should be made to disburse the particulate material into the tornado as early as possible. Hurricanes, having a longer duration, should not be as time sensitive as tornados and should not present the same temporal difficulties as presented by tornados.

The quantities of the dust that is used will be in proportion to the general size of the tornado that is formed. As larger tornados include a larger volume of particulates and moisture, and higher total energies, it is likely that there will be a proportional relationship between the quantity of particulates introduced into a storm, and the size of the storm and that is why the dust quantity will be much less needed to stop the tornado or hurricane damages and will much more effective using modified cement bags as describe to be thrown using the cement bags at the bottom part of the funnel which will need much less dust to stop or reduce the storm damage.

A theoretical underpinning of the Applicant's invention relates from evidence accumulated relating to the mixing of dust and rain, and the effects of dust and rain mixtures on the behavior of storms. In particular, information gleaned from the effect of rain fall on dust storms, is believed to be a useful predictor of the effect of the introduction of small particulate matter into rain storms.

Examples exist of dust storms that were dissipated through the introduction of rain and moisture to the dust storm. For example, just before nightfall on 27 Apr. 2005, a huge sand storm occurred in Iraq. This sand storm was diminished after rain fell in the morning, resulting in a clear sky, and the end of the sand storm. Similarly, in June, 2007, a large dust storm struck Karachi, Pakistan. The dust storm was followed by a series of heavy rainfalls that resulted in a complete dissipation of the dust storm

A dust storm occurred in Phoenix, Arizona on 5 Jul. 2011. Environmental authorities in Arizona measured 6,348 micrograms per cubic meter of dust in the air of dust having a particle size of approximately 10 micrometers. These measurements can be used as an indication of the amount of dust required to destroy the spiraling cyclonic storms, such as tornados and hurricanes. It is believed that particulate matter of a sufficient quantity to achieve approximate 6,000 micrograms per cubic meter is pumped into the tornado or hurricane funnels body which will be sucked up (due to negative pressures in the funnel), this quantity will result in a partial or fill dissipation of the tornado or hurricane.

An interesting phenomena that has been found to be related to dust storms that is believed to have an impact on the present invention relates to the electrical, and more particularly, the static electrical charges that are caused by airborne particulate matter.

Dust storms are initiated due to the presence of small particulate matter comprising soil particles that become loosely held onto the surface of the ground due to drought or arid conditions in farm or dessert areas, wherein moisture is lacking. As moisture serves as something of a binding agent for binding soil particles together, the lack of moisture reduces the forces that hold particles together, thus permitting them to become airborne under the influence of wind. The creation of dust to sand storms is most commonly caused by strong pressure gradients that cause a wind velocity over a wide arid area that permits the particulate matter formerly on the ground to become airborne.

Surprisingly, it has been found that as small particulate matter under the influence of wind become airborne, the particulates rub against each other. This rubbing of particles creates a positive charge close to the surface of the ground, and that imparts a negative charge on the particles themselves. The electrical field created by these charges can become strong enough to lift the sand or other particulate matter from the surface to enable the particulate matter to become airborne.

It is believed that the dust that is introduced in a storm funnel will exert a similar electric charge.

As water is a highly polar molecule, any charge provided by particles can be used to help attract water molecules to the particle, to thus enable the water to more quickly and thoroughly be absorbed by the absorbent particulate matter.

B. Delivery Vehicles; the likely path of a tornado or hurricane (direction can be given by the weather center and UPS coordinates of the expected position of tornado and at what time).

Preferably, a sufficient quantity of this fine particulate material is added to the storm to fully cover the inner part of the storms or at least partially the center and funnel body of the tornado or hurricane, or at least partially cover the tornado or hurricane inner cloud. The particular matter so introduced into the hurricane or tornado mixes with the moisture in suspension or as rain drops and fine water particles that make up the tornado or hurricane inner part body will

According to one aspect of the present invention, a water absorbent fine particulate material is employed. The fine particulate material can comprise a material such as dust, silt, clay, fine cement, fine chalk, talcum powder, ash, water absorbent manufactured powders or any natural or man-made fine particles that mix well in water. The absorbent materials should be capable of mixing well enough in water, so as to absorb a large amount of water.

Preferably, a sufficient quantity of this fine particulate material is added to the storm to fully cover or at least partially the body of the tornado or hurricane, or at least partially covers the tornado or hurricane cloud. The particular matter so introduced into the hurricane or tornado mixes with the moisture in suspension or as rain drops and fine water particles that make up the tornado or hurricane body will mix with the fine particulate matter to make clay like particles that are heavy enough to disturb the tornado spiraling sequence and cause a loss of energy to the twisting motion of the tornado to thereby dissipate the energy of rotation within the tornado.

The dust itself can preferably be a fine dessert sand having the diameter of approximately a micron or so.

The particulate should generally be small in size. Preferably, the particulate matter is smaller than fine sand (0.2 mm). Ideally, the particulate size is somewhere in the silt or fine silt range, generally being less than 0.063 mm in diameter. One benefit of particulates this size is that they are generally susceptible to becoming airborne, and carried by the wind. Among the types of materials that can fall within this size range, include such materials as fine cement particles, fine chalk particles, talcum powders, ashes and any natural or man-made fibers that mix well with water.

Absorbent manufactured products that will mix readily with water and are very easily carried by air in the form of dust will work well with the present invention. Further, chemical additives can be added to the small particulate matter, to enhance the ability of the particulate matter to absorb water or moisture, or to better mix with the moisture, and to better form into clay-like rain droplets.

As the preferred particulate matter is very prone to absorbing water, it is preferable to keep the particulate material as dry as possible, prior to its introduction into the storm to better help to preserve its water absorbing capacity. To this end, it may be useful to provide water resistant or water proof carriers that can help maintain the dryness of the absorbent material.

One such carrier comprises a bag-like carrier that is made of water proof material. Preferably, the material from which the particulate carrier is made should be strong enough to contain the particulate material, but still capable of shattering easily to release the dust into the atmosphere.

Examples of such material include plastic containers, reinforced paper, or other materials that have water proof or water resistant characteristics and that can be designed to be opened easily, either manually or remotely. For example, bags can be employed that include small timed explosive charges, that can be remotely detonated, while the bag is in the storm, so that the bag explodes to thereby release the particulate materials.

One way to help facilitate the moisture proofing of the materials is to vacuum seal the bags, to keep the water or moisture out and to maintain the water and moisture from contacting the dust.

The dust operates to help dissipate the tornado by mingling and mixing with the water vapor and moisture within a tornado or hurricane. This mixing and mingling is facilitated by ionization charge between the dust and the water vapor, rain drops and other moisture within the storm.

Additionally, physical contact type mixing between the dust and the water, will cause the particulate matter particles to become heavier due to the absorption of water by the particulate material. These heavier particles form clay-like mixtures, that will develop in a manner similar to a manner in which hail stones develop. These clay-like droplets will reduce the velocity of water particles that are absorbed by the clay materials due to the loss of energy and the destruction of the bonds and sequence in the tornado and hurricane structure.

Due to the loss of spinning energy possessed by the tornado, the rotation sequence and rotation strength of the cyclonic forces of the tornado are weakened. The reduction of the cyclonic movement of the forces tends to turn the tornado into more of a “vertical” rainstorm having clay-like droplets, rather than the cyclonic storm with the spiraling cyclonic winds that typically characterize a tornado or hurricane. The reduction of these cyclonic forces helps to reduce the energy of the tornado, and hence, the potential of the tornado to cause harm and destruction to both property and life forms.

The clay-like droplets that are formed through the introduction of the particulate matter will descend in small quantities without any harm in much the same manner that very small hail stones will fall to earth.

Preferably, the dust is thrown in bags as described earlier to disburse inside the lower part of the tornado, through vehicles that are capable of rising above the tornado to drop the particulate matter downwardly into the tornado or storm. Preferably, the particulate matter bags are disbursed into the center of the tornado or into the eye or cloud body of a hurricane. This invention predicts that the particulate matter is most effectively deployed into the tornado or hurricane at an early point in the life-cycle of the tornado or hurricane. Since tornados are usually short duration storms, some temporal difficulties will exist in trying to insert the particulate material into the tornado. Nonetheless, efforts should be made to disburse the particulate material into the tornado as early as possible. Hurricanes, having a longer duration, should not be as time sensitive as tornados and should not present the same temporal difficulties as presented by tornados.

The quantities of the dust that is used will be in proportion to the general size of the tornado that is formed. As larger tornados include a larger volume of particulates and moisture, and higher total energies, it is likely that there will be a proportional relationship between the quantity of particulates introduced into a storm, and the size of the storm.

A theoretical underpinning of the Applicant's invention relates from evidence accumulated relating to the mixing of dust and rain, and the effects of dust and rain mixtures on the behavior of storms. In particular, information gleaned from the effect of rain fall on dust storms, is believed to be a useful predictor of the effect of the introduction of small particulate matter into rain storms.

### B. Delivery Vehicles (the Likely Path of a Tornado or Hurricane)

### 1) Fixed and Rotary Wing Aircraft.

(Direction can be given by the weather center and GPS coordinates of the expected position of tornado and at what time).

One form of delivery vehicle that could well be employed to carry the modified cement bags as described previously to introduce the particulate material into funnel of a storm or hurricane is an aircraft. Aircraft can be employed in a manner similar to the manner in which aircraft have been employed to drop fire retardant chemicals into forest fires. In particular, tanker-type or bomber-type aircraft can be loaded with modified cement bags filled with fine clay, fine sand, bags of particulate material. The aircraft can then fly above the storm eye and release its load of particulate material into the storm funnel. It is believed that certain aircraft would he large enough to have a sufficient payload capacity to carry a sufficient amount of particulate material into a tornado or hurricane, in order to provide sufficient material to help dissipate the tornado. A variety of fixed wing aircraft are used currently in this role. For example, small cargo planes exist that are capable of carrying somewhere between 1 and 5 tons of dust bags. Medium cargo aircraft exist that are believed capable of carrying 5 to 30 tons of dust bags like material. Additionally, a large, military cargo plane, such as the Hercules C130 or C5 Transport plane should be capable of carrying several tons of dust bags as the load capacity of a C130 Transport plane is believed to be around 42,000 pounds or 21 tons. Even larger, the maximum payload capacity of the largest current military transports, such as the

C17 is approximately 170,900 pounds (77,519 kilograms) or 85 tons. The C5 Galaxy has a payload capacity of approximately 270,000 pounds (122,470 kg) 135 tons.

Due to the cost of purchasing and operating planes such as the C5 and C17, the use of such planes may be restricted with the present invention. Additionally, large commercial airliners can be equipped to carry loads of dust bags.

Older airplanes that can likely be purchased for a lower cost, and operated less expensively, might have particular value and use in connection with the present invention. Many older planes, are very reliable, can be purchased inexpensively and would adapt well for use with the present invention, since they would be subjected to the low number of cycles, due to a general infrequency of use. Examples of such planes include the Douglas DC7, and the Martin JRM

Mars. Both of these planes are 1940s-1950s vintage, large, 4-engine cargo transport planes. The particulate bag matter can be loaded into the cargo bay of the plane, with the pilot of the “dust bag bomber” plane overflying the storm, and dumping a load of particulate bag matter in a dispersal pattern at the funnel that suits the particular circumstances of the storm into which the particulate matter is being dumped. Dumping dust bags concurrently from wing dust bags can focus the particulate matter on the eye area of the tornado or hurricane.

Additionally, the airplane can be outfitted with dust spray pipes or nozzles, that are coupled to air pumps with nozzles that are fixed to the bottom of the wings. Such air pumps, pipes and nozzles can spray the particulate matter into the storm funnel center. Through the proper placement and dispersal characteristics of a nozzle, the fine dust can be sprayed from the planes over much larger areas in the storm funnel.

Although it is generally believed that it is preferable that the plane fly above the tornado type storm, the particular altitude that the plane flies, the type of plane employed and the size of the cargo plane will be determined by budgetary constraints, availability of certain planes and particularities of the storm itself. Factors in a tornado, such as the size, diameter and altitude of the top of the tornado (or the cloud from which it depends) will determine the altitude at which the plane should fly in order to best introduce its particulate matter bags into the tornado funnel center.

An alternative of the aircraft delivery vehicle is a rotary wing or helicopter.

Currently, cargo helicopters exist that could be adapted to deliver the particulate matter to carry the particulate matter, either in bulk nozzle into the funnel or in modified bag forms. For example, the Sikorsky Blackhawk helicopter should have a cargo capacity that will enable it to carry approximately 4,000 kg. (8,800 pounds) of particulate matter bags This particular matter bags can be dumped by the helicopter in dust dispersing zones above a storm funnel center. Due to the high maneuverability of helicopters it is believed that helicopters, while not being able to carry as much particulate matter as a fixed wing airplane, would have an advantage in their ability to precisely apply the particulate matter nozzles or bags to the desired areas.

Preferably, the helicopters could be outfitted with spray pipes and nozzles that employ air pumps that would permit the dust to be sprayed out the funnels in a pattern over the storm funnel center that would most advantageously maximize the potential of the dust particles to absorb water.

Further, helicopters could carry a dust hose that could be lowered into a storm funnel center to help deliver particulate matter into the interior of the storm.

### 2. Dust Balloons

Balloons could also be employed to carry large numbers of modified dust bags, to large heights, which dust bags, could then be dropped dust bags into a storm funnel center. It is believed that gas balloons should exist that could be capable of carrying somewhere between at least about 1 ton to 10 tons of particulate matter bags. These balloons would preferably be tethered to the ground, and to each other, using ropes if necessary, to maintain the dust balloons in an appropriate altitude position and an appropriate latitude position with respect to each other.

In one embodiment of the present invention, the dust balloons could be arrayed in a “dust balloon” minefield at height where the storm or tornado or hurricane funnels are most likely to pass. In particular, the dust balloons could be transported to an area that is positioned in the likely path of a tornado or hurricane and placed at the most likely level of the tornado funnels to pass (direction &levels can be given by the weather center and GPS coordinates of the expected position of tornado and at what time).

A plurality of dust balloons could be then placed in a pattern similar to the pattern in which mines would be placed in a mine field. The dust balloons would then be released, but tethered to the earth so that the dust balloons could travel up to an appropriate atmosphere where the funnels will be. When the dust balloons are impacted by a storm, the dust bags that were carried aloft by the dust balloons could be opened by the sheer force of the tornado funnel rotating wind force or remotely, such as when using explosive charges within the dust bags to cause the dust to be dispersed within the storm.

It will be appreciated that such a mine field of dust balloons would serve like a storm fence, that, when contacted by the storm, will be sucked in into the center of the funnel (lower pressure exists) would tend to inject storm dissipating dust into the tornado or hurricane to thereby reduce the power and energy of the tornado or hurricane, thereby reducing its destructive capabilities.

In one embodiment, the balloons should be tethered together, so that when a particular balloon or pairs of balloons were struck by the storm, the adjacent balloons would be pulled toward the balloon that was contacted by the tornado, so that a plurality of balloons would be pulled into the tornado so that their loads of particulate matter could be dispersed into the tornado. These connected dust balloons can be placed in a straight line, like a fence, or placed in a circle, or placed in a two-dimensional array.

The amount and size of the balloons that are employed will likely vary, depending upon the size of the storm that is anticipated, and the logistical ability to affix the dust balloons at a point ahead of the likely path of the storm. The dust balloons can also be large or small, depending upon a variety of factors, and can be designed to carry anywhere, for example, between 200 kg., and 1,000 kgs., per balloon, and, collectively carry tons of particulate matter, if a large plurality of balloons is used.

The balloons can be fitted with sensors including noise sensors, pressure sensors, radar sensors and the like, to provide ground personnel with information that can be useable by ground personnel to better help employ the balloons to disperse particulate matter into the storms. For example, explosive charges may be inserted into the dust bags to cause the dust bags to explode, to thereby disperse the dust contained therein. Sensors such as pressure and radar sensors could be monitored by controllers on the ground to enable those controllers to best know when to detonate the explosives to disperse the dust, to maximize the impact of the dispersed particulate matter on the storm that the particulate matter is being used to help dissipate.

The particulate matter containing balloons can be made from any material that is impervious to gas, and that is capable of successfully containing and mixing gas, such as hydrogen or helium.

Materials such as Mylar, nylon plastic with rubber or fiber, and parachute material can be made to be gas impervious to service such balloons. Additionally, the material traditionally used to create weather balloons can be employed.

The dust balloons can be designed to be made up in advance, and then transported to the potential site where they will be employed. Alternately, the dust balloons can be constructed, but allowed to remain empty of particulates, and then filled on site from bulk carriers, such as bulk carrying trucks that are equipped with pumps that can pump the particulate matter into the dust bags or cargo carrying departments of the balloons. Additionally, such tank-like trucks can be employed that include a quantity of stored gas such as helium or hydrogen that can be inserted into the balloons to inflate the balloons quickly. By enabling the balloons to be inflated at the site of deployment, one could reduce the storage issues attendant to maintaining filled balloons.

Balloons are generally passive transport devices, since normally balloons do not include a source of motive power, and are free to be dispersed by the wind. However active motor forces can be attached to the balloon in the form of rockets, gas jets or fans that are remotely controlled from the ground to enable ground personnel to better maneuver the balloons into a position wherein the particulate matter can be dispersed to maximize effectiveness. In one especially preferred embodiment, the balloons are equipped with four directional jet valves or rockets, to enable the balloon to be vectored in any direction necessary, for maneuvering the balloon into position in the eye of a hurricane or funnel of a tornado, by remote control from the ground, to place the balloon in the optimal position for dispersal of the particulate matter in a manner that will optimize its effectiveness in dispersing the storm or tornado.

The balloons described above can be standard shaped, and similar to the ones used in normal conditions. However, preferably, the balloons are modified to facilitate quick inflation.

Because of the transient nature of storms, it is likely that users of the present invention will often have constrained time frames in which to place their dust carrying vehicles, such as balloons, aircraft and the like, into a position where in the dust carrying vehicles can disperse their particular matter into the storm. As such, the component used with any dispersion vehicle should be designed with these temporal constraints in mind, and should be designed to include features that will speed up the deployment process. For example, although a particular tornado can form in a matter of seconds and disperse in a matter of minutes, the super cells that create such tornados usually have a significantly longer life span, and may be active for several hours or days, as the storm front passes over large geographic areas, such as several mid-western states.

Therefore, providing for particulate matter storage stations and vehicle filling stations that are geographically distributed around high tornado probability areas, such as tornado alley, such as at airports would be beneficial airplanes and helicopters with particulate matter. Additionally, the use of high capacity pumps at these fill stations would be very beneficial in reducing the time required to fully equip and load the particulate matter delivery vehicles.

Additionally, if delivery vehicles were activated at the creation of the storm cell, and the delivery vehicles were launched to be airborne and positioned near the areas wherein funnel cloud creation was most likely, the ability of the delivery vehicle to actually disperse the particulate matter within the storm would be enhanced.

Another feature that would enhance such readiness would be modifications that were applied to the delivery vehicles that enabled the particulate matter to be off-loaded quickly, if the particulate material was not used in a particular storm. Although such off-loading could occur quite quickly if the particulate matter was allowed to disperse over, for example, a rural area or off-shore, cost considerations might also dictate that a mechanical off-loader might be provided to off-load the particulate material to replace it back into its storage facility. The return of the unused particulate matter to its storage facility would then prevent the particulate matter from being wasted. The degree to which such wastage could impact the program would depend largely on the costs of the particulate matter, and the damage (if any) that would be caused by the loads not being dumped to disperse the storm, but rather to empty the delivery vehicle.

In a preferred embodiment, the balloons could be torus (donut) shaped, so that they would comprise rings, with a central aperture. An extended steel shaft after any strong pipe could be extended through the central aperture to hold such torus shaped balloons with their dust bags.

Although the balloons would be empty, the dust bags could be full, and ready to be used. In such a situation, the steel pipe containing a plurality of balloons, could be positioned adjacent to an inflator so that they could be quickly inflated and released from the steel pole and allowed to float upwardly into a position wherein the balloons would have a high probability of being able to disperse the particulate matter contained within the dust bags into the storm. Depending on the needs of the user, the particular balloons that were held onto the steel pipe, could be tethered together or allowed to be separated. Explosives remotely controlled or attached to extended ropes to control the opening of the clay bags at the required height

Trucks could be used to transport the balloons to the location of the storm. Any truck or transport vehicle used to transport the balloons should be designed and positioned for a quick release of the balloons if necessary. If the trucks were used in connection with the torus shaped balloons described above, the truck could be outfitted with a plurality of telescoping steel tubes on which the balloons could be mounted. It is believed by the Applicant that 10 balloon units or more could be stacked on top of each other, and prepared for individual inflation and mounted on the back of a truck or the like.

In some situations, it may be desirable to equip such trucks with a body portion, having side 75 walls, similar to a box truck. By having at least side walls, the balloons placed inside the walls could be sheltered from high winds, thus making it easier for the balloons to be inflated and released. A quickly removable roof, such as a canvas tarp, might be useful to facilitate a quick launch of the balloons on the side wall containing truck bed.

### 3. Dust Pumping System

Another delivery vehicle for delivering particulate matter into a storm is a pumping system.

Currently, cement pumps exist that can deliver dry cement to almost any height, given the necessary engine power for providing a vacuum and pumping station that is strong enough and high volume enough to pump the cement to the desired height.

In this manner, a pipe, such as a 4 or 10 inch pipe, carrying the particulate matter (fine clay, cement, dust) of the present invention into or near the funnel of the tornado that can be carried along by balloons of the type described above. Because of the weight contained within the dust pipe, a large number of balloons may be required to lift such a dust pipe into position. One benefit of using such a carrying pipe is that one would not be as limited in the quantity of particulate matter that could be delivered to the storm, as one would be with some of the dust delivery systems described above, such as the balloon.

In addition to the dust pipes being carried aloft by balloon, such dust pipes could also be carried aloft by aircraft, such as helicopters. These dust pipes could be directed to deliver dust into the perimeters of the tornado funnel, or into the center of the tornado. Anchored to the ground end of these dust hoses would be transport trucks that were capable of carrying sufficiently large quantities of particulate matter of the type according to the present invention that would serve as the feed stock for the particulate matter being fed into the pipes, and delivered to the storm funnel.

### 4. Hot Air Balloons

Another variant on the balloons discussed above are hot air balloons without gas blowers. Hot air balloons, without the gas blower or fuel cylinders, can be loaded with dust bags and allowed to lift aloft to penetrate the tornado body funnel or the hurricane body funnel. Placing the balloons at the perimeter of the tornado or hurricane will likely cause the balloons to be sucked into the interior (eye) of the hurricane or directly into the funnel of the tornado.

When sucked into the storm, the dust bags will explode, either under their own volition and design, or due to the rope turning the dust bag upside down, or the placement and detonation of explosive charges within the particulate matter bags. Remote controls and sensors can be employed to enable the user to detonate the bags at an appropriate time, and to determine the time at which the bags should be exploded.

Such hot air balloons can be filled rather quickly with a variety of tools for generating hot air.

Hot air can be generated by combusting flammable materials contained in fuel cylinders and introducing the hot air so created by the burned material in the fuel cylinders into the interior of the balloon. Preferably, the hot air introduced into the balloon should be greater than 150′ C and preferably about 200′ C. When heating the material, it is important to not allow the heated material to exceed the melting point of the particular material from which the balloon is made.

For example, it is believed that certain nylons can withstand materials to approximately 230′C (450′F), without suffering from structural degradation.

In order to reinforce such balloons to make them more heat resistant, the cloth from which a balloon can be made can be insulated with a fiberglass insulation, to thereby help the heat of the hot air from melting the material from which the balloons are made.

Another vehicle for introducing hot air into the balloons can comprise the exhaust produced by a diesel or gas engine. Such engine exhaust can be introduced into a balloon and create the required air/gas temperatures. The exhaust from the combustion engine such as a diesel or gas engine can be introduced into the balloon using tubes and valves, without the need for additional gas cylinder heaters or fuel cylinders. Such connections between the exhaust of internal combustion engines and the balloons should be provided with valves for quickly being able to shut down the production of gas into the balloon when the balloon reaches capacity, and also for quickly disconnecting the balloon and its filling hose from the exhaust of the vehicle.

Diesel engines and gas engines are believed to have the potential to serve as good not air producing sources due to the fact that the exhaust temperatures typically achieved by gas and diesel engines are about 400°. As the exhaust gases taken from a position closer to the combustion chamber of the engine are hotter, this temperature of the exhaust can be reach approximately 900° F.

Optimally, the user can adjust the temperatures of the gas by adjusting the fuel and air mixture that is delivered to the vehicles. It has been found that higher gas exhaust temperatures are achieved when the fuel mixture is made to be “rich”, wherein an excess of fuel, and a reduced amount of air are fed into the combustion chamber.

One benefit of the use of the exhaust from a combustion engine as the vehicle for filling the hot air balloons is that such hot air sources are ultimately mobile. For example, storm chasers and others, who move around to follow storms, can take their source of exhaust gas with them by virtue of the car or truck in which they are driving. When they reach the point wherein the hot air balloons are to be inflated and released, they can simply attach the balloons through a suitable tube to the exhaust output of their vehicles, either at the tail pipe, or through a special port disposed closer to the exhaust manifold of the vehicle, so as to produce hotter air that can be delivered into the balloons to more quickly inflate them.

For typical atmosphere conditions of 20° C. (68° F.), a hot air balloon that is heated to 99° C. (210° F.) requires about 3.91 cubic meters of envelope volume to lift one kilogram at 120° C.

### 5. Ballistic Carriers

Another delivery vehicle comprises shells, rockets, or other ballistic projectiles that would be shot or launched into a tornado funnel. Such ballistic materials would be comprised of shells that were sturdy enough to be launched by a ballistics launch mechanism, such as a Howitzer or rocket engine, but which could be flimsy enough in order to be capable of breaking open to disperse the particulate matter within the storm. As discussed above, explosive charges placed in such particulate shells could be employed to break open the casing in which the dust is contained when the casing was launched into the storm funnel.

All forms of normal or modified military artillery could be employed to launch such shells.

However, it is important that the shells be made of a material such as a light weight plastic that is not going to cause any great shrapnel damage or other damages after the shells are exploded, and the shell materials are allowed to fall to the ground.

Preferably, the shell should be modified so as to carry a large amount of dust. It is believed that larger shells can be employed if the range of the shells is kept relatively short. Explosive charges are preferably placed inside of the shells to be ignited by a timer, or some sort of sensor, so as to cause the explosive charge to explode when the shell is in an optimal position to release the dust to help dissipate the storm body itself. The dust shells can include tracers to help those shooting the shells to locate the path of the shell panel, to enable the user to better improve their aim.

Grenade throwers have a large front tank can be employed to help maximise the loads of dust that are carried by such ballistic vehicles. The number of artillery or ballistic dust shells that need to be fired into a particular storm is that number that carries a sufficient amount of particulate matter to disturb the tornado's cyclonic and rotating sequence, by providing enough particulate matter that is capable of absorbing enough moisture, so that the moisture latent particular matters can help to rob energy from the storm to thereby dissipate the storm by depriving the storm of its energy.

In addition to shells, rockets filled with dust or dust bags can also be employed. The Applicant believes that several types of old style rockets can be used to appropriately guide the dust bags into the interior of the storm funnel system. Such old style rockets can include wire guided missile, and other various missiles and munitions, that because of advances in ballistic and military technology, or otherwise outdated for use in military purposes. Although such shells and rockets and transports may be outdated when used in connection with military purposes, it is possible that such shells and rockets would still have utility for transporting large quantities of dust bags into a storm.

Such rockets and shells can be supplied by the military and used in cooperation with weather agencies. Additionally, fireworks type launch vehicles could also be used to help transport particulate matter bags into a storm funnel. One benefit that the use of such fireworks would include is that such fireworks are usually already equipped with an explosive powder. As will be appreciated, a normal “rocket flare” type firework will be shot into the air. Upon reaching a certain height, the rocket will explode to shower lighted displays. This explosion could be rigged into the dust bag, to cause the dust bag to explode when in the storm funnel, to thereby help to distribute the particulate matter within the storm.

The amount of particulate that must be placed in the storm will depend to a large extent upon the size of the particular storm, along with the energy of the storm as reflected in its speed, size and strength of the winds.

It will also be appreciated that the amount of particulate matter that is most appropriately introduced to a storm will likely be determined through empirical evidence gathered through experimentation, along with computer modeling and the like.

Another method is to use remotely condoled trucks carrying covered fin clay dust or cement and an very powerful air pump to pump air into the dust which is directed toward the funnel mouth by sending the truck to be underneath the tornado funnel remotely

Another method is to use parachutes put on the ground where the expected storm to be coming (use GPS alarm) and are attached to dust bags with ropes and when the storm come near these parachutes they will be filled with spiral air at 70-100 mile per hour which will lift the parachutes and the dust bags into the tornado funnel due to the vacuum in the funnel(negative pressure)

Having described the invention in detail with respect to certain preferred embodiments, it will be appreciated that variations and modifications exist within the scope and spirit of the present invention, and the range of equivalence to which the present invention is entitled should be limited only by the law and the prior art.

One form of delivery vehicle that could well be employed to introduce the particulate material into a storm or hurricane is an aircraft. Aircraft can be employed in a manner similar to the manner in which aircraft have been employed to drop fire retardant chemicals into forest fires.

In particular, tanker-type or bomber-type aircraft can be loaded with either loose particulate material or bags of particulate material. The aircraft can then fly above the storm and release its load of particulate material into the storm. It is believed that certain aircraft would be large enough to have a sufficient payload capacity to carry a sufficient amount of particulate material into a tornado or hurricane, in order to provide sufficient material to help dissipate the tornado.

A variety of fixed wing aircraft are used currently in this role. For example, small cargo planes exist that are capable of carrying somewhere between 1 and 5 tons of dust. Medium cargo aircraft exist that are believed capable of carrying 5 to 30 tons of dust like material.

Additionally, a large, military cargo plane, such as the Hercules C130 or C5 Transport plane should be capable of carrying several tons of dust as the load capacity of a C130 Transport plane is believed to be around 42,000 pounds or 21 tons.

Even larger, the maximum payload capacity of the largest current military transports, such as the C17 is approximately 170,900 pounds (77,519 kilograms) or 85 tons. The C5 Galaxy has a payload capacity of approximately 270,000 pounds (122,470 kg) 135 tons.

Due to the cost of purchasing and operating planes such as the C5 and C17, the use of such planes may be restricted with the present invention. Additionally, large commercial airliners can be equipped to carry loads of dust.

Older airplanes that can likely be purchased for a lower cost, and operated less expensively, might have particular value and use in connection with the present invention. Many older planes, are very reliable, can be purchased inexpensively and would adapt well for use with the present invention, since they would be subjected to the low number of cycles, due to a general infrequency of use. Examples of such planes include the Douglas DC7, and the Martin JRM Mars. Both of these planes are 1940s-1950s vintage, large, 4-engine cargo transport planes.

The particulate matter can be loaded into the cargo bay of the plane, with the pilot of the “dust bomber” plane overflying the storm, and dumping a load of particulate matter in a dispersal pattern that suits the particular circumstances of the storm into which the particulate matter is being dumped. Dumping dust concurrently from wing dust tanks can focus the particulate matter on the eye area of the tornado or hurricane, while dumping the particulate matter out of four dust tanks in sequence mainly to better dust mixing within the storm.

Additionally, the airplane can be outfitted with dust spray pipes or nozzles, that are coupled to air pumps, that are fixed to the bottom of the wings. Such air pumps, pipes and nozzles can spray the particulate matter into the storm. Through the proper placement and dispersal characteristics of a nozzle, the fine dust can be sprayed from the planes over much larger areas in the storm.

Although it is generally believed that it is preferable that the plane fly above the tornado type storm, the particular altitude that the plane flies, the type of plane employed and the size of the cargo plane will be determined by budgetary constraints, availability of certain planes and particularities of the storm itself. Factors in a tornado, such as the size, diameter and altitude of the top of the tornado (or the cloud from which it depends) will determine the altitude at which the plane should fly in order to best introduce its particulate matter into the tornado.

An alternative of the aircraft delivery vehicle is a rotary wing or helicopter.

Currently, cargo helicopters exist that could be adapted to deliver the particulate matter to carry the particulate matter, either in bulk or in bag forms. For example, the Sikorsky Blackhawk helicopter should have a cargo capacity that will enable it to carry approximately 4,000 kg. (8,800 pounds) of particulate matter. This particular matter can be dumped by the helicopter in dust dispersing zones above a storm. Due to the high maneuverability of helicopters it is believed that helicopters, while not being able to carry as much particulate matter as a fixed wing airplane, would have an advantage in their ability to precisely apply the particulate matter to the desired areas.

Preferably, the helicopters could be outfitted with spray pipes and nozzles that employ air pumps that would permit the dust to be sprayed out in a pattern over the storm that would most advantageously maximize the potential of the dust particles to absorb water.

Further, helicopters could carry a dust hose that could be lowered into a storm to help deliver particulate matter into the interior of the storm.

The claimed invention is:

1) Stopping tornadoes and hurricanes by disturbing the root of its driving forces as they are powered by the source of warm air in the updraft, as the warm moist air is pulled upward, the moisture within the air condenses and this latent heat of condensation is an exothermic event which provides power and create an extremely low pressure area within the center of the tornado or hurricanes and happen within the eye of the tornadoes or hurricanes and close to the ground
And the Introduction of dust or cement or similar material into the lower part of the funnel will disturb the root cause of the tornados or hurricanes, at the lower part of the funnel or the eye near the ground, this latent heat of condensation is exothermatic, and generates energy, and the clay dust or cement or similar material will promote the dissipation the tornado or hurricane by using (Dust Particles) which is needed to stop and dissipate the tornadoes or hurricanes, by using cement bags carrying cement, fine clay or any fine particle absorbing water with straps attached to the cement bags and by carrying bags and airplane to let the bags open with the cement bags upward are turned 180 degree vertically making the mouth of the bags facing the ground at specific strap length(or timed small explosives) which is determined on the airplane carrier height above the lower part of the tornado or hurricanes and will give the starting point of the fine clay or cement to start spreading in the funnel lower part near the ground and dissipate the tornado and hurricanes

2) Throwing cement and clay dust, into to the perimeters, will not stop the tornadoes or hurricanes due to the upcoming storm winds from the earth direction to the upper parts and dispersed
The empty cement bags will do no harm to human or the properties when dropped from the sky
And when tornados meet fine dust clay or fine dust sand on the ground in sufficient quantity, the tornados are completely dissipated or weaken depending on the fine clay dust and sand dust
And the invention principal can be seen in reveres in ARIZONA STATE and the Middle East deserts (HABOB-sand storms) when meeting rain storms all the sky will be clear in very short time, and this applies in reveres to the sand storms by using firefighters throwing water on the dust storms.
